(19) United States
(12) Patent Application Publication
(10) Pub. No.: US 2014/0328976 A1
(43) Pub. Date: Nov. 6, 2014

(54) ENZYMATICALLY HYDROLYSED LIPIDS AS FLAVOUR INGREDIENTS

(71) Applicant: NESTEC S.A., Vevey (CH)

(72) Inventors: Tuong Huynh-Ba, Pully (CH); Stephanie Devaud Goumoens, Porsel (CH); Walter Matthey- Doret, Prilly (CH); Francoise Saucy, St-Saphorin (CH); Florian Viton, Lausanne 26 (CH); Catherine Barbier, Singen (DE)

(21) Appl. No.: 14/362,350

(22) PCT Filed: Nov. 30, 2012
(86) PCT No.: PCT/EP12/74028

§ 371 Date: Jun. 2, 2014

(30) Foreign Application Priority Data
Dec. 12, 2011 (EP) 11192923.8

(51) Int. Cl. A23L 1/231; A23L 1/23

(52) U.S. Cl. CPC A23L 1/231; A23L 1/23; A23V 2002/00
USPC 426/33; 426/608; 426/589; 426/549

(57) ABSTRACT

A process for preparing a flavour concentrate having a meat flavour and/or aroma, comprising contacting animal lipid with a lipase enzyme, such that at least some triglycerides present in the lipid are hydrolysed, to give a mixture of free fatty acids, monoglycerides, diglycerides and non-hydrolyzed triglycerides; heating the mixture to inactivate the lipase; and heating the mixture with an aqueous solution containing at least one reducing sugar and at least one amino acid to give the flavour concentrate.

### TECHNICAL FIELD

This invention relates to the enzymatic partial hydrolysis of lipids to create a fat ingredient of a flavour concentrate having a potent flavour and good emulsification characteristics in Maillard-type flavour generation reactions. In particular, the invention relates to a process for preparing a flavouring ingredient including lipase-catalysed partial hydrolysis of animal oils and fats to generate in situ mixtures of free fatty acids, monoglycerides and diglycerides, as well as non-hydrolysed triglycerides, which can be used in a flavour concentrate to generate a meat flavour and/or aroma.

### BACKGROUND

Flavours and aromas generated during the cooking of foods, particularly meat, are complex. As a consequence, the generation of certain flavours or aromas is difficult to control, both during the food preparation process prior to cooking and during the cooking process itself. Moreover, consumer preferences continue to develop in sophistication and hence drive the need for improved control over food flavours and aromas in order to meet consumer demands. One example of this sophistication and subtlety is the demand for an aroma in some foods that resembles a boiled chicken flavour rather than a roasted chicken flavour. But the aroma components of a boiled chicken flavour are complex and a number of aroma building blocks are usually required for generating or improving this flavour.

It is well-known that Maillard reactions and lipid oxidation reactions are the two most important types of reaction responsible for flavour development in foods. Performing these reactions in an appropriate matrix can be an effective way to mimic real food systems by maximising the interactions between Maillard reactions and lipid oxidation reactions to generate and/or enhance the desired flavours and aromas for a particular food. One example of this is the use of water-in-oil emulsions as described in WO 2010/008452. The invention described relates to the use of a structured lipid phase, known as an internally self-assembled structure (ISA), for generating Maillard flavours. An ISA structure is generated using fat or oil in combination with water and an exogenous emulsifier (i.e. Dimodan®, a commercial monoglyceride) within which the Maillard reactions take place with reduced reaction times and temperatures.

However, ISA systems have limitations in respect of their application to some food products. One drawback is that the use of a flavour generated in an ISA system as a flavouring ingredient for some food products leads to a strong mouth coating sensation and a bitter taste. This can be managed by using only a small quantity of the ISA-generated flavour, but then its flavouring impact is strongly limited. Another disadvantage is that the addition of ISA systems containing flavour precursors to enhance the flavour intensity of other processed flavours or food products that are rich in water can result in processing difficulties, in particular flocculation of the incorporated ISA system presumably due to the formation of emulsifier/water cubic phases.

Current industrial processes for producing chicken flavours involve the heating of a mixture of carbohydrates (e.g. glucose, xylose), amino acids (e.g. glycine, cysteine, proline) and chicken fat. When no emulsifier is used, high reaction temperatures and/or long reaction times are necessary to maximise interactions with the lipid ingredient and achieve the chicken flavour. As the result of Maillard reactions that occur in these conditions and limited interactions with the lipid ingredient, a roast chicken flavour is obtained. This is acceptable for some food flavouring applications, but can be a limitation for others where a boiled chicken flavour is strongly preferred. The addition of an emulsifier (i.e. an exogenous emulsifier) enables reaction times and temperatures to be reduced and maximises interactions between Maillard products and lipid oxidation products thereby creating the conditions to develop a boiled chicken flavour. But emulsifiers tend to lead to the problems mentioned above, i.e. strong mouth coating feel, bitterness, and difficult processing in water-rich matrices, in addition to the non-natural character of typical emulsifiers used.

Furthermore, even the use of certain emulsifiers can lead to chicken flavours that suffer from a low boiled chicken character and low flavour intensity despite the lower reaction temperatures enabled by the presence of the emulsifier.

Another disadvantage of the use of exogenous emulsifiers is that emulsifiers originating from vegetable oils tend to generate odorants by auto-oxidation of the oils which are unrelated to the chicken flavour. The formation of these odorants therefore means that flavour ingredients prepared using such emulsifiers generally lack the desired specificity of the chicken flavour.

Naturalness of food products is an increasingly important attribute sought by consumers. Since many emulsifiers used in the food industry require identification on the packaging of food products as additives, there is a perception that the presence or use of an emulsifier is unnatural and therefore at least some consumers will decide not to use such products.

Some attempts have been made to avoid or overcome some of these problems using biological processes.

Chinese patent application number 200710172681 (published as CN101194704A) discloses a method for producing meat flavours by enzymatic hydrolysis of adipose tissues of different animal origins using commercially available enzymes followed by thermal cracking at very high temperatures (150° C. to 300° C.) under an oxygen flow. The method yields a fatty product with meaty flavour. However, the flavour is limited in complexity because the method does not involve any in-process generation of a meat flavour and/or aroma via Maillard reactions.

Zhong Qui et al. (Journal of Chinese Institute of Food Science and Technology, 2010, 10(4), 124-129) disclose the preparation of chicken flavours from chicken fat that has been oxidised by enzymatic catalysis followed by a thermal reaction. The chicken fat was oxidised using a crude lipoxygenase extracted from defatted soymeal to provide triglyceride hydroperoxides. The resulting oxidised chicken fat was subjected to a thermal reaction with amino acids and reducing sugars, leading to the generation of a strong chicken flavour. Again, the richness of aroma and the flavour profiles generated using this method are limited. The method reports the formation of triglyceride hydroperoxides only as the fatty ingredient contribution to the chicken flavour and aroma. There is no hydrolysis to generate free fatty acids, monoglycerides, or diglycerides.

The applicant has now found that the in situ generation of free fatty acids, monoglycerides, and diglycerides provide higher oxidative reactivity and higher emulsification capacity therefore enhancing interactions between Maillard products and lipid oxidation products during flavour generation. This results in more complex flavour profiles closer to homemade cooked chicken preparations.

An object of the present invention is therefore to provide a process for preparing a flavour concentrate that at least goes part way to overcoming one or more of the above disadvantages of known flavour compositions.

### SUMMARY OF THE INVENTION

In a first aspect of the invention there is provided a process for preparing a flavour concentrate having a meat flavour and/or aroma, comprising the steps of:
a) contacting a composition comprising an animal lipid with a lipase enzyme, such that at least some triglycerides present in the lipid are hydrolysed, to give a mixture of free fatty acids (FFA), monoglycerides (MG), diglycerides (DG) and triglycerides (TG), and wherein the animal lipid is partially hydrolysed by the lipase enzyme;
b) heating the mixture to inactivate the lipase; and
c) heating the mixture with an aqueous solution containing at least one reducing sugar and at least one amino acid to give the flavour concentrate.

In a preferred embodiment of the process of the invention, the composition in step a) comprises at least 75%, preferably at least 85%, more preferably at least 90%, of an animal lipid. Even more preferably, the composition in step a) consists of an animal lipid.

The lipid is preferably animal fat, such as chicken, beef, pork, or lamb fat. Chicken fat is the preferred lipid of the invention.

Any suitable lipase may be used, which may be an exogenous enzyme or an endogenous enzyme. Examples of the exogenous enzyme include the commercially available enzyme Lipozyme TL. The endogenous enzyme may be obtained from fruit or vegetables such as an enzyme selected from a lipase from orange, desi orange, grapefruit, lemon, sardah, garma, muskmelon, apple, guava, mango, papaya, or simbal, turnip, radish, pot-herb, or tomato. The endogenous enzyme may alternatively be obtained from a microorganism such as a lipase from Pseudomonas fluorescens or Rhizomucor miehei.

In preferred embodiments of the invention, the mixture in step b) is heated to a temperature of greater than 100° C. for 10 to 30 minutes.

In step c), the reducing sugar may be dextrose or xylose, and the amino acid may be glycine, cysteine or proline.

In a second aspect of the invention there is provided a flavour concentrate prepared according to the first aspect. The concentrate preferably has a cooked chicken flavour profile that is closer to boiled chicken than to roast chicken.

In another aspect of the invention there is provided a food product containing a flavour concentration of the invention. The food product may be, although is not limited to, a soup, bouillon cube, culinary aid, sauce, savoury snack, prepared dish such as baked lasagne or macaroni and cheese, pizza, or Hot Pockets®, or a food intended for animal consumption such as extruded dry kibbles, baked kibbles, or retorted wet pet foods.

### BRIEF DESCRIPTION OF THE DRAWINGS

FIG. 1 shows a sensory profile of the chicken flavour prepared according to Example 1.4 compared to a reference chicken flavour prepared according to Example 1.3.

FIG. 2 shows a sensory profile of a chicken flavour prepared according to Example 2.4 compared to a reference chicken flavour prepared according to Example 1.3.

FIG. 3 shows a sensory profile of a chicken flavour prepared according to Example 3.3 compared to a reference chicken flavour prepared according to Example 1.3.

FIG. 4 shows sensory profiles of chicken flavours prepared according to Examples 1.4, 2.4 and 3.3 compared to a reference chicken flavour prepared according to Example 1.3.

### DETAILED DESCRIPTION

The invention relates to a process for preparing a flavour concentration having a meat flavour and/or aroma. In a first step, animal lipid is treated with a lipase enzyme under conditions suitable to at least partially hydrolyse triglycerides of the lipid component. This partial hydrolysis results in a mixture of free fatty acids, monoglycerides, and diglycerides as well as un-hydrolysed triglycerides. Following the hydrolysis step, the mixture is heated to inactivate the lipase. An aqueous solution containing at least one reducing sugar and at least one amino acid is then added and the mixture heated to initiate flavour generating Maillard reactions thereby producing the flavour concentrate.

As used herein, the term “lipid” means a group of naturally occurring hydrophobic or amphiphilic small molecules that include fats, oils, monoglycerides, diglycerides, triglycerides, and phospholipids.

As used herein, the term “fatty acid” means a carboxylic acid with a long aliphatic chain, which may be saturated or unsaturated. Most naturally occurring fatty acids have a chain of an even number of carbon atoms, from 4 to 28. When not attached to other molecules, they are known as “free” fatty acids.

As used herein, the term “monoglyceride” means an ester formed from glycerol and one fatty acid, and is also known as a monoacylglycerol. The term “diglyceride” means an ester formed from a single glycerol molecule and two fatty acids, and is also known as a diacylglycerol. The term “triglyceride” means an ester formed from a single glycerol molecule and three fatty acids, and is also known as a triacylglycerol.

As used herein, the term “lipase” means an enzyme that catalyses the hydrolysis of lipids.

As used herein, the term “reducing sugar” means any sugar that either has an aldehyde group or is capable of forming one in solution through isomerisation.

The invention is applicable to animal lipids. Various animal lipids may be used, for example those present in beef, pork or lamb fat, but chicken fat is preferred because of the need to find chicken flavours of higher intensity and depth, and more closely resembling boiled chicken flavours, than those chicken flavour products currently known.

The invention is based on the partial hydrolysis of triglycerides using a lipase enzyme. In contrast to complete hydrolysis, where all triglycerides would be hydrolysed to free fatty acids, partial hydrolysis results in a mixture of free fatty acids, monoglycerides, diglycerides and triglycerides. An important advantage is that such a mixture has good emulsification properties. Thus, there is no need to add an exogenous emulsifier to enable reaction times and temperatures to be reduced or to maximise the interactions between water-soluble ingredients and lipidic ingredients for generating complex and rich flavours that closely resemble homemade preparations. Therefore the common problems associated with the addition of emulsifiers, i.e. strong mouth coating feel, bitterness, and difficult processing in water-rich matrices, are avoided.

Another important advantage is that the overall intensity of the flavours produced is significantly greater than the flavour intensity when untreated lipid is used. For example, the use of partially enzyme-hydrolysed chicken fat was found to provide flavours of higher intensity and, more particularly, the specificity of boiled chicken flavour was significantly improved compared to a chicken flavour produced in, for example, an ISA system as described in WO 2010/008452. It is considered that enzyme-hydrolysed chicken fat generates volatile compounds, particularly aldehydes, which contribute to the chicken flavour intensity and specificity, which are not found to the same degree when untreated chicken fat is used or when an exogenous emulsifier is added.

The lipase hydrolysis may be conducted at any suitable temperature, but may typically be in the range 30° C. to 50° C. in order that the lipid used is melted. Any suitable lipase may be used, for example commercial enzymes such as Lipozyme TL (as used in the Examples below), endogenous enzymes from fruits and vegetables, including lipases from orange, desi orange, grapefruit, lemon, sardah, garma, muskmelon, apple, guava, mango, papaya, simbal, turnip, radish, pot-herb, and tomato, as well as lipases from microorganisms, for example lipases from Pseudomonas fluorescens and Rhizomucor miehei. In typical lipase hydrolysis reactions, the lipid is treated with the lipase for 30 minutes with stirring at, for example, 600 rpm before heating to deactivate the lipase. The lipase deactivating step is normally carried out at greater than 100° C., for example 160° C. However, it should be appreciated that any reaction conditions that give the desired hydrolysis are applicable to this invention.

After this lipid hydrolysis step, the mixture preferably comprises free fatty acids (FFA) in an amount of 1-35% as measured per total amount of the animal lipids present in the mixture. More preferably, the mixture comprises free fatty acids (FFA) in an amount of 1-15% per total amount of the animal lipids.

Furthermore, after this hydrolysis step, the mixture preferably comprises the triglycerides (TG) in an amount of 40-98% as measured per total amount of the animal lipids present in the mixture. In a separate embodiment, the mixture comprises the triglycerides (TG) in an amount of 60-97% as per total amount of the animal lipids.

Following hydrolysis of the lipid, one or more sugars and amino acids in aqueous solution are added and the mixture heated to enable flavour generating Maillard reactions and lipid oxidation reactions to take place and interact. Any suitable reducing sugar may be added including, but not limited to, dextrose or xylose. Typical amino acids added include, but again not limited to, glycine, cysteine or proline. It should be appreciated that the purified or semi-purified amino acids themselves do not need to be added, but they may be added in the form of any mixture or other compound that contains the amino acid residues such as proteins, peptides and fragments thereof.

In preferred embodiments of the invention, partially enzyme-hydrolyzed chicken fat is used, instead of untreated chicken fat together with Dimodan® monoglyceride emulsifier (ISA system), to produce processed chicken flavours for use in the food industry. The eggy, sulfury, fatty, and boiled chicken flavour notes (which all contribute to a boiled chicken flavour character) increase relative to a reference ISA chicken flavour processed with untreated chicken fat and Dimodan® (ISA system). The overall intensity also increased as well as the boiled chicken intensity and chicken specificity, while the off-flavour drawbacks (e.g. strong mouth coating sensation and astringency/bitterness) and processability limitations due to Dimodan® were surprisingly depleted.

The enhancement of the chicken flavour specificity can also be accounted for by the avoidance of exogenous emulsifiers such as Dimodan®. Emulsifiers that originate from vegetable oils are capable of generating odorants that are unrelated to the chicken flavours and may diminish the intensity and specificity of the desirable chicken flavours.

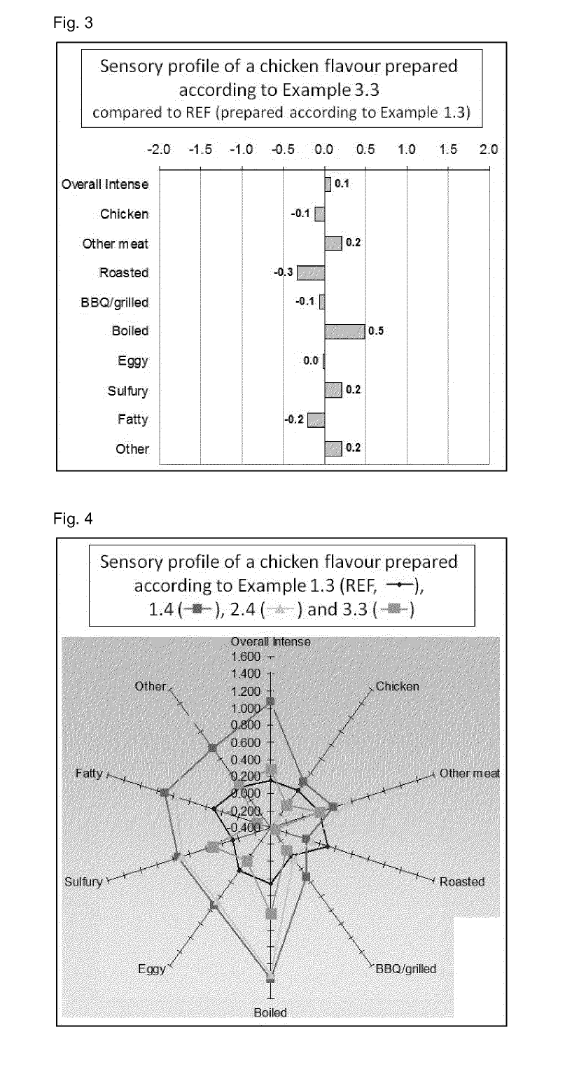

FIG. 4 is a star profile showing sensory profiles of chicken flavours prepared according to Examples 1 to 3 compared to a reference chicken flavour. Examples 1 and 2 below show clearly that the use of partially enzymatically hydrolyzed chicken fat according to Example 1 and Example 2 leads to enhancement of chicken flavour intensity and significant differences in the attributes evaluated by sensory panels when compared to a reference chicken flavour or to a chicken flavour prepared according to WO 2010/008452.

The flavour concentrate of the invention may be in various forms, for example a liquid suspension or solution, a viscous solution or gel, solid powder or granules.

Food products prepared from the flavour concentrate of the invention include any food, feed, snack, food supplement, treat, meal substitute, or meal replacement, whether intended for human or another animal consumption. In particular, food products prepared from the flavour concentrate of the invention include soups, bouillon cubes, culinary aids, sauces, savoury snacks and treats, prepared dishes such as baked lasagne or macaroni and cheese, frozen and chilled pizzas or Hot Pockets® but also foods intended for animal consumption such as extruded dry kibbles or treats, baked kibbles or treats or retorted wet petfoods.

### EXAMPLES

The invention is further described with reference to the following examples. It will be appreciated that the invention as claimed is not intended to be limited in any way by these examples.

### Materials and Methods

The evolution of the free fatty acids (FFA), monoglycerides (MG), diglycerides (DG) and triglycerides (TG) profiles during partial enzymatic hydrolysis of chicken fats were qualitatively followed by GC-FID after derivatisation by silylation with trimethylsilyl chloride (TMSCl) and N,O-bis(trimethylsilyl)trifluoroacetamide (BSTFA).

Silylation protocol: 0.5 g of analyte was mixed with 1.5 mL dichloromethane, vortexed and dried over sodium sulphate. Then 0.2 mL of the supernatant was mixed with a solution of 1% TMSCl in BSTFA and placed in a drying oven at 65° C. for 2 hours. Before GC-FID analysis, the sample was diluted 5 times.

GC-FID analysis: GC-FID analysis was performed on a HP6890 chromatograph equipped with a Zebron ZB-5HT inferno column. The temperature profile applied was the following: the initial temperature was set to 80° C., followed by a first ramp of 2° C./min up to 180° C., a second ramp at 10° C./min up to 360° C., and a final stage at 360° C. for 25 min.

Sensory evaluations were performed by comparative profiling against a reference chicken flavour using a comparative profiling scale ranging from −5 to +5 with the reference being placed at 0. The sensory analysis was performed by a trained panel of 12 panelists, previously screened for their sensory abilities. The performance of the panel was validated with a panel performance test. The flavoured samples were evaluated over the following sensory attributes: overall intensity, chicken, other meat, roasted, BBQ/grilled, boiled, eggy, sulfury, fatty, other notes.

### Example 1

### Example 1.1: Preparation of Partially Enzymatically Hydrolyzed Chicken Fat

90 g of chicken fat was melted and heated in a Schott bottle up to 50° C. and stirred at 600 rpm. 2.25 mL of a solution consisting of 20% of the lipase mix (Lipozyme TL 100 L) in 1.0 M phosphate buffer at pH 7.6 was added to the chicken fat and the Schott bottle was closed. The reaction mixture was then stirred at 600 rpm for 30 min. The Schott bottle containing the partially enzymatically hydrolyzed chicken fat sample was then transferred to an oil bath pre-heated at 160° C. for 15 min in order to inactivate the lipase and stop further activity. GC-FID analysis of this sample showed the following glyceride profile: 1.4% FFA, 0% MG, 1.9% DG and 96.5% TG.

### Example 1.2: Preparation of Reducing Sugar and Amino Acid Solutions

Solutions of reducing sugars and amino acids in 0.2 M phosphate buffer were prepared separately to prevent Maillard reactions from starting at room temperature. 6.0 g of dextrose monohydrate and 1.11 g of xylose powder were dissolved at room temperature in 5 mL of phosphate buffer 0.2 M at pH 7.5 in a 10 mL volumetric flask. The pH was readjusted to the target value (pH 7.5) with a few drops of NaOH 1.0 M and the mixture was gauged with the phosphate buffer to 10 mL. 1.37 g of glycine, 1.03 g of L-cysteine hydrochloride monohydrate and 0.17 g of L-proline were dissolved at room temperature in 5 mL of phosphate buffer 0.2 M at pH 7.5 in a 10 mL volumetric flask. The pH was readjusted to the target value (pH 7.5) with a few drops of NaOH 5.0 M and the mixture was gauged with the phosphate buffer to 10 mL.

### Example 1.3: Preparation of a Reference Chicken Flavour

A reference chicken flavour was prepared as follow: 10.0 mL of an aqueous mixture made from 1.5 mL of the above solution of reducing sugars (containing 0.9 g of dextrose monohydrate and 0.16 g of xylose powder), 3.5 mL of the above solution of amino acids (containing 0.48 g of glycine, 0.36 g of L-cysteine hydrochloride monohydrate and 0.06 g of L-proline) and 5 mL of water were added to 90 g of chicken fat pre-heated at 40° C. in a glass reactor. The reactor was then closed and the reaction mixture was heated at 85° C. for 30 min under stirring at 1000 rpm. The obtained reference chicken flavour was then cooled to room temperature.

### Example 1.4: Preparation of a Chicken Flavour According to the Invention

A chicken flavour was prepared as follow: 7.75 mL of an aqueous mixture made of 1.5 mL of the above solution of reducing sugars (containing 0.9 g of dextrose monohydrate and 0.16 g of xylose powder), 3.5 mL of the above solution of amino acids (containing 0.48 g of glycine, 0.36 g of L-cysteine hydrochloride monohydrate and 0.06 g of L-proline) and 2.75 mL of water were added to 92.25 g of the above prepared partially enzymatically hydrolyzed chicken fat (already containing 2.25 mL of water from the lipase mix) pre-heated at 40° C. in a glass reactor. The reactor was then closed and the reaction mixture was heated at 85° C. for 30 min under stirring at 1000 rpm. The chicken flavour obtained was then cooled to room temperature.

### Example 1.5: Sensory Evaluation of the Chicken Flavour Prepared According to Example 1.4

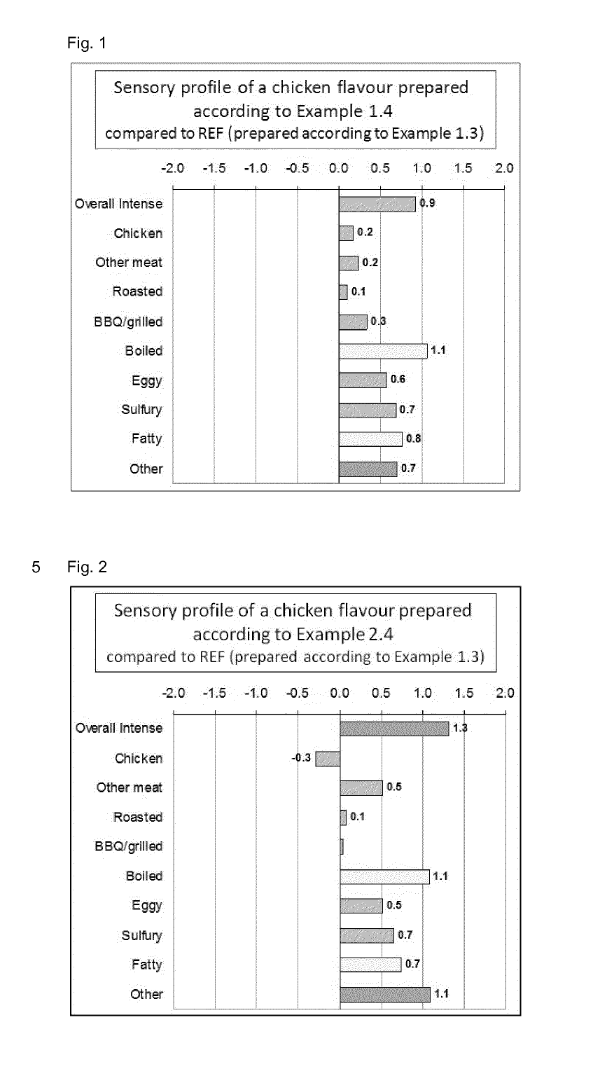

The chicken flavour obtained from Example 1.4 was compared to the reference chicken flavour of Example 1.3. The results are shown in FIG. 1. Significant increases in “overall intensity”, “boiled”, “fatty” and “other” attributes were observed for the chicken flavour prepared according to Example 1.4 when compared to the reference chicken flavour of Example 1.3. An increasing trend was also observed for the “eggy” and “sulfury” attributes, which contribute to the boiled character of a chicken flavour. These results clearly demonstrate the advantage of preparing a chicken flavour concentrate according to the process of the invention.

### Example 2

### Example 2.1: Preparation of Partially Enzymatically Hydrolyzed Chicken Fat

90 g of chicken fat was melted and heated in a Schott bottle up to 40° C. and stirred at 600 rpm. 4.5 mL of a solution consisting of 20% of the lipase mix (Lipozyme TL 100 L) in 1.0 M phosphate buffer at pH 7.6 was added to the chicken fat and the Schott bottle was closed. The reaction mixture was then stirred at 600 rpm for 30 min. The Schott bottle containing the partially enzymatically hydrolyzed chicken fat sample was then transferred to an oil bath pre-heated at 160° C. for 15 min in order to inactivate the lipase and stop further activity. GC-FID analysis of this sample showed the following glyceride profile: 10.3% FFA, 1.4% MG, 15.1% DG and 73.1% TG.

### Example 2.2: Preparation of Reducing Sugar and Amino Acid Solutions

Solutions of reducing sugars and amino acids in 0.2 M phosphate buffer were prepared separately to prevent Maillard reactions from starting at room temperature. 6.0 g of dextrose monohydrate and 1.11 g of xylose powder were dissolved at room temperature in 5 mL of phosphate buffer 0.2 M at pH 7.5 in a 10 mL volumetric flask. The pH was readjusted to the target value (pH 7.5) with a few drops of NaOH 1.0 M and the mixture was gauged with the phosphate buffer to 10 mL. 1.37 g of glycine, 1.03 g of L-cysteine hydrochloride monohydrate and 0.17 g of L-proline were dissolved at room temperature in 5 mL of phosphate buffer 0.2 M at pH 7.5 in a 10 mL volumetric flask. The pH was readjusted to the target value (pH 7.5) with a few drops of NaOH 5.0 M and the mixture was gauged with the phosphate buffer to 10 mL.

### Example 2.3: Preparation of a Reference Chicken Flavour

A reference chicken flavour was prepared as described in Example 1.3.

### Example 2.4: Preparation of a Chicken Flavour According to the Invention

A chicken flavour according to the invention was prepared as follow: 5.5 mL of an aqueous mixture made of 1.5 mL of the above solution of reducing sugars (containing 0.9 g of dextrose monohydrate and 0.16 g of xylose powder), 3.5 mL of the above solution of amino acids (containing 0.48 g of glycine, 0.36 g of L-cysteine hydrochloride monohydrate and 0.06 g of L-proline) and 0.5 mL of water were added to 94.5 g of the above prepared partially enzymatically hydrolyzed chicken fat (already containing 4.5 mL of water from the lipase mix) pre-heated at 40° C. in a glass reactor. The reactor was then closed and the reaction mixture was heated at 85° C. for 30 min under stirring at 1000 rpm. The chicken flavour obtained was then cooled to room temperature.

### Example 2.5: Sensory Evaluation of the Chicken Flavour Prepared According to Example 2.4

The chicken flavour obtained from Example 2.4 was compared to the reference chicken flavour of Example 2.3. The results are shown in FIG. 2. Significant increases in “overall intensity”, “boiled”, “fatty” and “other” attributes were observed for the chicken flavour prepared according to Example 2.4 when compared to the reference chicken flavour of Example 2.3. An increasing trend was also observed for the “eggy” and “sulfury” attributes, which contribute to the boiled character of a chicken flavour. These results clearly demonstrate the advantage of preparing a chicken flavour concentrate according to the process of the invention.

### Example 3

### Example 3.1: Preparation of Reducing Sugar and Amino Acid Solutions

Solutions of reducing sugars and amino acids in 0.2 M phosphate buffer were prepared separately to prevent the Maillard reaction from already starting at room temperature. 6.0 g of dextrose monohydrate and 1.11 g of xylose powder were dissolved at room temperature in 5 mL of phosphate buffer 0.2 M at pH 7.5 in a 10 mL volumetric flask. The pH was readjusted to the target value (pH 7.5) with a few drops of NaOH 1.0 M and the mixture was gauged with the phosphate buffer to 10 mL. 1.37 g of glycine, 1.03 g of L-cysteine hydrochloride monohydrate and 0.17 g of L-proline were dissolved at room temperature in 5 mL of phosphate buffer 0.2 M at pH 7.5 in a 10 mL volumetric flask. The pH was readjusted to the target value (pH 7.5) with a few drops of NaOH 5.0 M and the mixture was gauged with the phosphate buffer to 10 mL.

### Example 3.2: Preparation of a Reference Chicken Flavour

A reference chicken flavour was prepared as described in Example 1.3.

### Example 3.3: Preparation of a Chicken Flavour in an ISA System According to WO 2010/008452

10.0 mL of an aqueous mixture made from 1.5 mL of the above solution of reducing sugars (containing 0.9 g of dextrose monohydrate and 0.16 g of xylose powder), 3.5 mL of the above solution of amino acids (containing 0.48 g of glycine, 0.36 g of L-cysteine hydrochloride monohydrate and 0.06 g of L-proline) and 5 mL of water were added to a mixture of 31.6 g of chicken fat and 58.4 g of emulsifier Dimodan U/J pre-heated at 40° C. in a glass reactor. This mixture was stirred at 1600 rpm until a clear homogeneous mixture formed. The reactor was then closed and the reaction mixture was heated at 85° C. for 30 min under stirring at 1000 rpm. The obtained reference chicken flavour was then cooled to room temperature.

### Example 3.4: Sensory Evaluation of the Chicken Flavour Prepared According to WO 2010/008452

The chicken flavour obtained according to Example 3.3 was compared to the reference chicken flavour of Example 3.2. The results of this comparison are shown in FIG. 3. As can be seen from FIG. 3 no significant differences were observed for the chicken flavour prepared according to Example 3.3 when compared to the reference chicken flavour of Example 3.2 in terms of the 10 attributes evaluated.

### Example 4

Food samples were prepared by diluting the chicken flavour concentrates prepared according to Example 1.4 (5, 10, 25 weight %), Example 2.4 (5, 10, 25 weight %) and Example 3.3 (5, 10, 25 weight %) into a standard chicken fat. These food samples were tasted on small pieces of bread (approx. 1.0 g of fat per portion) and compared to a standard chicken fat. For samples containing chicken flavour concentrate prepared according to Examples 1.4 and 2.4 (i.e. prepared according to the invention) the sensory assessors reported no noticeable differences compared to standard chicken fat in terms of mouth coating sensation and bitterness, even with the sample containing the highest level of in situ generated emulsifiers (25% dilution of flavouring concentrate prepared according to Example 2) while describing intense boiled chicken flavours. In sharp contrast for samples containing the chicken flavour concentrate prepared according to Example 3.3 (i.e. prepared according to WO 2010/008452) the sensory assessors reported a strong mouth coating and bitter sensations at 5% dilution, thus precluding the evaluation of samples at higher dosages. These results clearly demonstrate another advantage of preparing a chicken flavour concentrate according to the process of the invention.

### Example 5

A base for tasting was prepared by dissolving NaCl (6.5 g/L), sucrose (1.6 g/L), MSG (4.0 g/L), IMP/GMP (0.2 g/L) and yeast extract (4.0 g/L) in hot water (65-70° C.). 0.815 g (5% by weight versus base ingredients) of chicken flavour concentrates prepared according to, respectively, Examples 1.3, 2.4 and 3.3 were added to 500 mL of this base for tasting. For comparison, a reference sample containing standard chicken fat (0.815 g chicken fat in 500 mL of this base) was also evaluated. For the base containing chicken flavour concentrates prepared according to Example 1.3 and Example 2.4 (i.e. according to the invention) the sensory assessors reported no noticeable visual differences compared to the base containing standard chicken fat: all three samples had a similar aspect, showing only fat eyes and no insoluble white particles resulting from a flocculation phenomenon. When tasting these three samples, the sensory assessors reported no noticeable differences in terms of mouth coating and bitterness, and reported intense boiled chicken flavours. In sharp contrast for the sample containing the chicken flavour concentrate prepared according to Example 3.3 (i.e. prepared according to WO 2010/008452) the sensory assessors observed visual differences (presence of white particles resulting from a flocculation phenomenon) as well as strong mouth coating and bitter sensations when tasting the sample as compared to the base containing standard chicken fat. These results clearly demonstrate another advantage of preparing a chicken flavour concentrate according to the invention.

### Example 6

### Example 6.1: Preparation of Partially Enzymatically Hydrolyzed Chicken Fat

100 g of chicken fat was melted and heated in a reactor up to 45° C. and stirred at 150 rpm with IKA stirrer. 10% (w/w) water and 5% (w/w) lipase (Lipozyme TL 100L) chicken fat was added to the chicken fat and the reactor was closed. The system was then stirred at 150 rpm for 2 hr. The reactor containing the partially enzymatically hydrolyzed chicken fat was heated on a heating stir at 100° C. for 15 min in order to inactivate the lipase to stop the further activity. The FFA analysis results: 30% FFA.

### Example 6.2: Preparation of a Reaction Base for Chicken Maillard Reaction Solution

The base was prepared as followed which composed from food ingredients to keep naturalness, no chemical precursors added: the honey which was chosen as a reducing sugar source was added at dosage of 5% (w/w). 18% (w/w) Yeast extract, 5% (w/w) wheat gluten sauce powder, 5% (w/w) egg yolk powder and 5% (w/w) tomato paste were added as the nitrogen source. 1% (w/w) fresh spring onion and 1% (w/w) fresh ginger, 23% (w/w) salt and 22% (w/w) sugar were added. And 15% (w/w) water was added to make an aqueous mixture.

### Example 6.3: Preparation of a Chicken Maillard Reaction Solution with Chicken Fat

A reference chicken Maillard reaction solution was prepared as follow: 6 g normal chicken fat and 94 g above reaction base were added into one reactor and then heated at 98° C. for 70 min with stirring. The obtained chicken Maillard reaction solution as reference was then cooled to room temperature.

### Example 6.4: Preparation of Chicken Maillard Reaction Solution with Partially Enzymatically Hydrolyzed Chicken Fat

The chicken Maillard reaction solution with partially enzymatically hydrolyzed chicken fat was prepared as follow: 6 g partially enzymatically hydrolyzed chicken fat and 94 g above reaction base were added into one reactor and then heated at 95° C. for 50 min with stirring. The obtained chicken Maillard reaction solution was then cooled to room temperature.

### Example 6.5: Sensory Evaluation of the Chicken Maillard Reaction Solution Prepared According to Example 6.4

The chicken Maillard reaction solution from example 6.4 was compared to the reference chicken Maillard reaction solution of example 6.3. The aroma and taste of chicken on “meaty” and “fatty” was enhanced. These results clearly demonstrate the advantage of preparing a chicken Maillard reaction solution concentrate according to the process of the invention.

### Example 7

### Example 7.1: Preparation of Partially Enzymatically Hydrolyzed Beef Fat

100 g of beef fat was melted and heated in a reactor up to 55° C. and stirred at 150 rpm with IKA stirrer. 10% (w/w) water and 5% (w/w) lipase (Lipozyme TL 100L) was added to the beef fat and the reactor was closed. The system was then stirred at 150 rpm for 4 hr. The reactor containing the partially enzymatically hydrolyzed beef fat was heated on a heating stir at 100° C. for 15 min in order to inactivate the lipase to stop the further activity. The FFA analysis results: 34.02% FFA.

### Example 7.2: Preparation of a Reaction Base for Beef Maillard Reaction Solution

The base was prepared as followed which composed from food ingredients to keep naturalness, no chemical precursors added: the honey which was chosen as the reducing sugar source was added at dosage of 13% (w/w). 20% (w/w) Yeast extract, 5% (w/w) wheat gluten sauce powder and 10% (w/w) tomato paste were added as the nitrogen source. Then 0.5% (w/w) black pepper, 5% (w/w) fresh shallot, 23% (w/w) salt and 15.5% (w/w) sugar were added. 8% (w/w) water was added to make an aqueous mixture.

### Example 7.3: Preparation of a Beef Maillard Reaction Solution with Normal Beef Fat

A beef Maillard reaction solution with normal beef fat was prepared as followed: 6 g normal beef fat and 94 g above reaction base were added into one reactor and then heated at 93° C. for 50 min with stirring. The obtained beef Maillard reaction solution as reference was then cooled to room temperature.

### Example 7.4: Preparation of a Beef Maillard Reaction Solution with Partially Enzymatically Hydrolyzed Beef Fat

The beef Maillard reaction solution with partially enzymatically hydrolyzed beef fat was prepared as follow: 6 g partially enzymatically hydrolyzed beef fat and 94 g above reaction base were added into one reactor and then heated at 93° C. for 50 min with stirring. The obtained beef Maillard reaction solution was then cooled to room temperature.

### Example 7.5: Sensory Evaluation of the Beef Maillard Reaction Solution Prepared According to Example 7.4

The beef Maillard reaction solution from example 7.4 was compared to the beef Maillard reaction solution as reference of example 7.3. The significant increase of beef “meaty” and “fatty” aroma and taste were obtained. These results clearly demonstrated the advantage of preparing a beef Maillard reaction solution concentrate according to the process of the invention.

It is to be appreciated that although the invention has been described with reference to specific embodiments, variations and modifications may be made without departing from the scope of the invention as defined in the claims. Furthermore, where known equivalents exist to specific features, such equivalents are incorporated as if specifically referred to in this specification.

1. A process for preparing a flavor concentrate having a meat flavor and/or aroma, comprising the steps of:
contacting a composition comprising an animal lipid with a lipase enzyme, such that at least some triglycerides present in the lipid are hydrolysed, to give a mixture of free fatty acids, monoglycerides, diglycerides and triglycerides, and wherein the animal lipid is partially hydrolysed by the lipase enzyme;
heating the mixture to inactivate the lipase; and
heating the mixture with an aqueous solution containing at least one reducing sugar and at least one amino acid to give the flavor concentrate.

2. The process as of claim 1, wherein the composition comprises at least 75%, of an animal lipid.

3. The process of claim 1, wherein the composition consists of an animal lipid.

4. The process of claim 1, wherein the animal lipid is a fat selected from the group consisting of chicken fat, beef fat, pork fat, lamb fat and combinations thereof.

5. The process of claim 1, wherein the lipase enzyme is Lipozyme TL and/or a lipase enzyme selected from the group consisting of orange, desi orange, grapefruit, lemon, sardah, garma, muskmelon, apple, guava, mango, papaya, simbal, turnip, radish, pot-herb and tomato.

6. The process of claim 1, wherein the lipase enzyme is obtained from a microorganism.

7. The process of claim 1, wherein the mixture is heated to a temperature of greater than 100° C. for 10 to 30 minutes to inactivate the lipase.

8. The process of claim 1, wherein the at least one reducing sugar is dextrose or xylose.

9. The process of claim 1, wherein the at least one amino acid is selected from the group consisting of glycine, cysteine and proline.

10. The process of claim 1, wherein the mixture comprises the free fatty acids in an amount of 1-35% based on the total amount of the animal lipids.

11. The process of claim 1, wherein the mixture comprises the triglycerides in an amount of 40-98% based on the total amount of the animal lipids.

12. A flavor concentrate obtainable by a process comprising the steps of: contacting a composition comprising an animal lipid with a lipase enzyme, such that at least some triglycerides present in the lipid are hydrolysed, to give a mixture of free fatty acids, monoglycerides, diglycerides and triglycerides, and wherein the animal lipid is partially hydrolysed by the lipase enzyme; heating the mixture to inactivate the lipase; and heating the mixture with an aqueous solution containing at least one reducing sugar and at least one amino acid to give the flavor concentrate.

13. A food product comprising a flavor concentrate having a meat flavor and/or aroma prepared by a method comprising the steps of:
contacting a composition comprising an animal lipid with a lipase enzyme, such that at least some triglycerides present in the lipid are hydrolysed, to give a mixture of free fatty acids, monoglycerides, diglycerides and triglycerides, and wherein the animal lipid is partially hydrolysed by the lipase enzyme;
heating the mixture to inactivate the lipase; and
heating the mixture with an aqueous solution containing at least one reducing sugar and at least one amino acid to give the flavor concentrate.

14. The food product as of claim 13, which is selected from the group consisting of a soup, bouillon cube, culinary aid, sauce, savoury snack, prepared dish, pizza and Hot Pocket®.

15. The food product of claim 13, which is intended for animal consumption selected from the group consisting of extruded dry kibbles, baked kibbles and retorted wet pet foods.
